(19) United States
(12) Patent Application Publication
(10) Pub. No.: US 2011/0171994 A1
(43) Pub. Date: Jul. 14, 2011

(54) MULTI-MODE TRANSCEIVER AND A CIRCUIT FOR OPERATING THE MULTI-MODE TRANSCEIVER

(75) Inventors: Gireesh RAJENDRAN, Trivandrum (IN); Timothy Don DAVIS, Arlington, TX (US); Apu SIVADAS, Bangalore (IN); Michel FRECHETTE, Plano, TX (US); Thiagarajan KRISHNASWAMY, Bangalore (IN); Salvatore PENNISI, Allen, TX (US); Rakesh KUMAR, Ghazipur (IN); Bijit Thakorbhai PATEL, Allen, TX (US); Subhashish MUKHERJEE, Bangalore (IN); Debapriya SAHU, Bangalore (IN)

(73) Assignee: Texas Instruments Incorporated, Dallas, TX (US)

(21) Appl. No.: 12/684,134

(22) Filed: Jan. 8, 2010

(51) Int. Cl. H04W 88/06

(52) U.S. Cl. 455/552.1

(57) ABSTRACT

Multi-mode transceiver and a circuit for operating the multi-mode transceiver. A multi-mode transceiver includes a first circuit that is configurable to operate as one of a transmitter and a receiver in a first mode, and a second circuit that is configurable to operate as one of the transmitter and the receiver in a second mode. The multi-mode transceiver includes a first element coupled to the first circuit. The multi-mode transceiver includes a second element coupled to the first element and one or more ports. The multi-mode transceiver also includes a first switch, coupled to the second element and to the second circuit, that is configurable to operate the transceiver in at least one of the first mode and the second mode in conjunction with the first element and the second element.

### TECHNICAL FIELD

Embodiments of the disclosure relate to a multi-mode transceiver.

### BACKGROUND

A radio frequency (RF) transceiver, typically, includes a high power amplifier in a transmitter section to transmit signals and a low noise amplifier in a receiver section to receive signals. The RF transceiver can transmit and receive the signals in a similar frequency band, for example 30 MHz to 300 MHz. Often, it is desired to transmit and receive the signals in multiple frequency bands or in the similar frequency band having different modes with different power levels, bandwidth and modulation. In one example, it can be desired to operate the RF transceiver in a first band having the frequency range of 30 MHz to 300 MHz and in a second band having the frequency range of 300 MHz to 3000 MHz. In another example, it is desired to operate the RF transceiver at same RF band, for example 2.4 GHz to 2.5 GHz in different modes, for example a bluetooth mode and a wireless local area network (WLAN) mode, having different power levels, bandwidth and modulation.

FIG. 1 illustrates a RF transceiver 105 in accordance with prior art. The RF transceiver 105 is coupled to a front end module 120 that enables the RF transceiver 105 to operate in the multiple frequency bands or in the similar frequency band having different modes with different power levels, bandwidth and modulation. The front end module 120 is coupled to an antenna 110 through a filter 115, for example a band pass filter (BPF). The RF transceiver 105 includes a portion 125 corresponding to the WLAN mode and a portion 130 corresponding to the bluetooth mode. The portion 125 includes a transmitting circuit 140A, for example a pre-power amplifier (PPA) and a receiving circuit 150A, for example a low noise amplifier (LNA) and the portion 130 includes a transmitting circuit 140B, for example the PPA and a receiving circuit 150B, for example the LNA. The front end module 120 matches and isolates signals in the multiple frequency bands using a matching circuit 145. The matching circuit 145 includes a matching network coupled to a power amplifier (PA). A switch 135, for example a transmit/receive/bluetooth switch (T/R/BT switch) in the front end module 120, is used to operate the RF transceiver 105 as one of a transmitter and a receiver in the WLAN mode and the bluetooth mode. The front end module 120 also includes a balun 155 that is active when the RF transceiver 105 works in the receive mode in the WLAN mode. However, having the front end module 120 is costly and increases area of an integrated circuit.

### SUMMARY

An example of a multi-mode transceiver includes a first circuit that is configurable to operate as one of a transmitter and a receiver in a first mode. The multi-mode transceiver also includes a second circuit that is configurable to operate as one of the transmitter and the receiver in a second mode. Further, the multi-mode transceiver includes a first element coupled to the first circuit. Furthermore, the multi-mode transceiver includes a second element coupled to the first element and one or more ports. The multi-mode transceiver also includes a first switch, coupled to the second element and to the second circuit, that is configurable to operate the multi-mode transceiver in at least one of the first mode and the second mode in conjunction with the first element and the second element.

An example of a multi-mode transmitter includes a first circuit that is configurable to operate in a first mode. The multi-mode transmitter includes a second circuit that is configurable to operate in a second mode. The multi-mode transmitter also includes a transformer that is coupled to the first circuit and the second circuit. The transformer acts as a switch to operate the multi-mode transmitter in one of the first mode and the second mode. Further, the multi-mode transmitter includes a plurality of switches coupled to the transformer. The plurality of switches is responsive to a biasing voltage to operate the multi-mode transmitter in one of the first mode and the second mode in conjunction with the transformer. The biasing voltage is generated based on a desired mode of operation of the multi-mode transmitter.

Another example of a multi-mode transceiver includes a first circuit that is configurable to operate as one of a transmitter and a receiver in a first mode. The multi-mode transceiver includes a second circuit that is configurable to operate as one of the transmitter and the receiver in a second mode. The multi-mode transceiver also includes a first capacitor coupled to one or more ports and the first circuit. The multi-mode transceiver further includes a second capacitor coupled to the one or more ports, the first capacitor and the second circuit. Further, the multi-mode transceiver includes a switch coupled to the second capacitor. The switch is responsive to a control signal to operate the multi-mode transceiver in at least one of the first mode and the second mode in conjunction with the first capacitor and the second capacitor. The control signal is generated based on a desired mode of operation of the multi-mode transceiver.

### BRIEF DESCRIPTION OF THE VIEWS OF DRAWINGS

FIG. 1 is a block diagram of a radio frequency transceiver, in accordance with prior art;

FIG. 2 is a block diagram of a multi-mode transceiver, in accordance with one embodiment;

FIG. 3 is a schematic representation of a portion of a multi-mode transceiver, in accordance with one embodiment;

FIG. 4A and FIG. 4B are schematic representations of a portion of a multi-mode transceiver in various modes, in accordance with one embodiment;

FIG. 5A and FIG. 5B are schematic representations of a portion of a multi-mode transceiver, in accordance with another embodiment;

FIG. 6 is a schematic representation of a multi-mode transmitter, in accordance with yet another embodiment;

FIG. 7A-FIG. 7E are schematic representations for transmitting signals in multiple modes in a multi-mode transmitter, in accordance with one embodiment;

FIG. 8 is a flow chart illustrating a method for operating a multi-mode transceiver, in accordance with one embodiment;

FIG. 9A is a graphical representation illustrating insertion loss for a multi-mode transceiver operating in wireless local area network mode, in accordance with one embodiment;

FIG. 9B is a graphical representation illustrating insertion loss for a multi-mode transceiver operating in a bluetooth mode, in accordance with one embodiment;

FIG. 9C is a graphical representation illustrating insertion loss for a multi-mode transceiver operating in wireless local area network mode and bluetooth mode, in accordance with one embodiment;

FIG. 10 is a graphical representation illustrating insertion loss for a multi-mode transceiver operating in wireless local area network mode and bluetooth mode, in accordance with another embodiment;

FIG. 11A is a graphical representation illustrating scattering parameter analysis for a multi-mode transceiver operating in wireless local area network mode, in accordance with one embodiment; and

FIG. 11B is a graphical representation illustrating scattering parameter analysis for a multi-mode transceiver operating in bluetooth mode, in accordance with one embodiment.

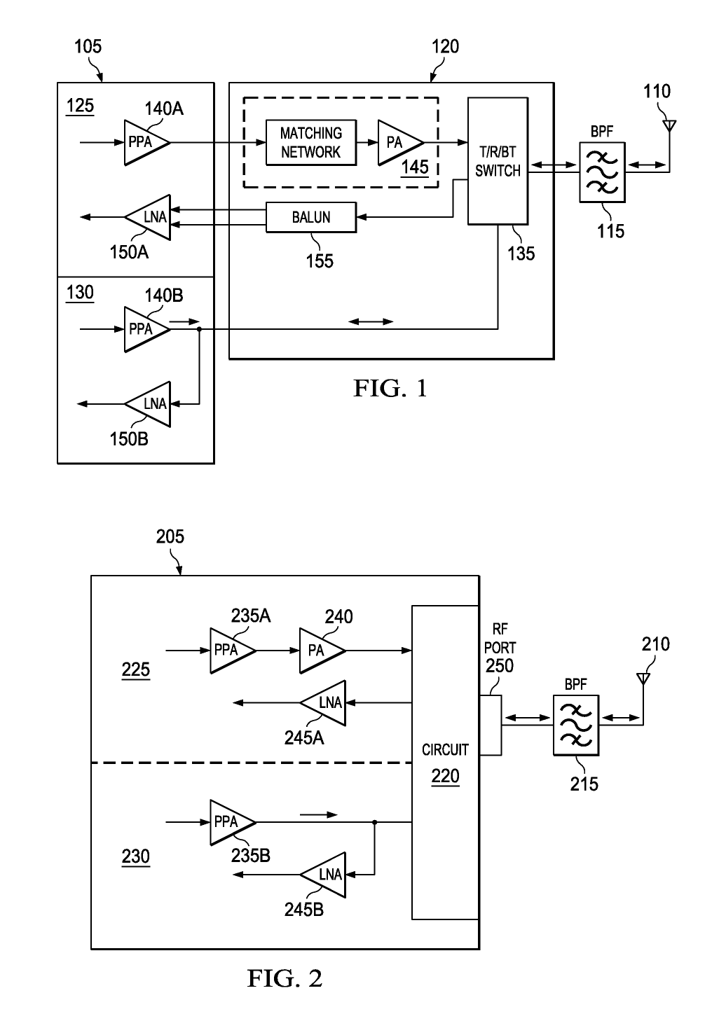

### DETAILED DESCRIPTION OF THE EMBODIMENTS

A multi-mode transceiver can transmit and receive signals in multiple modes. Examples of the modes include, but are not limited to, a wireless local area network (WLAN) mode, a bluetooth mode, a Zigbee mode, a wideband code division multiple access (W-CDMA) mode, an enhanced data rates for global system mobile communication evolution (EDGE) mode, a 3G mode, a 2.5G mode and a 2G mode. An example of a device using the multi-mode transceiver is a mobile phone. The multi-mode transceiver including various elements is explained in conjunction with FIG. 2.

FIG. 2 illustrates a multi-mode transceiver 205, hereinafter referred to as the transceiver 205. The transceiver 205 receives and transmits signals through an antenna 210. The transceiver 205 is coupled to the antenna 210 through a filter 215, for example a band pass filter (BPF).

The transceiver 205 includes a first circuit 225, hereinafter referred to as the circuit 225, corresponding to a first mode and a second circuit 230, hereinafter referred to as the circuit 230, corresponding to a second mode. In one example, the first mode corresponds to the WLAN mode and the second mode corresponds to the bluetooth mode. Each circuit includes a transmitting portion and a receiving portion. The transmitting portion is configurable to operate a circuit 220 as a transmitter and the receiving portion is configurable to operate the circuit 220 as a receiver. The circuit 225 includes a pre-power amplifier (PPA) circuit 235A coupled to a power amplifier (PA) 240 in the transmitting portion, and an amplifier 245A, for example a low noise amplifier (LNA), in the receiving portion. The PA 240 and the amplifier 245A are coupled to the circuit 220. The circuit 230 includes a PPA 235B in the transmitting portion, and an amplifier 245B, for example the LNA, in the receiving portion. The PPA 235B and the amplifier 245B are coupled to the circuit 220.

The circuit 220 can be coupled between a port 250, for example an RF port and one or more of the amplifier 245A, the amplifier 245B, the PA 240 and the PPA 235B. In some embodiments, the circuit 220 can be coupled between the PPA 235A and the PA 240 of the transceiver 205.

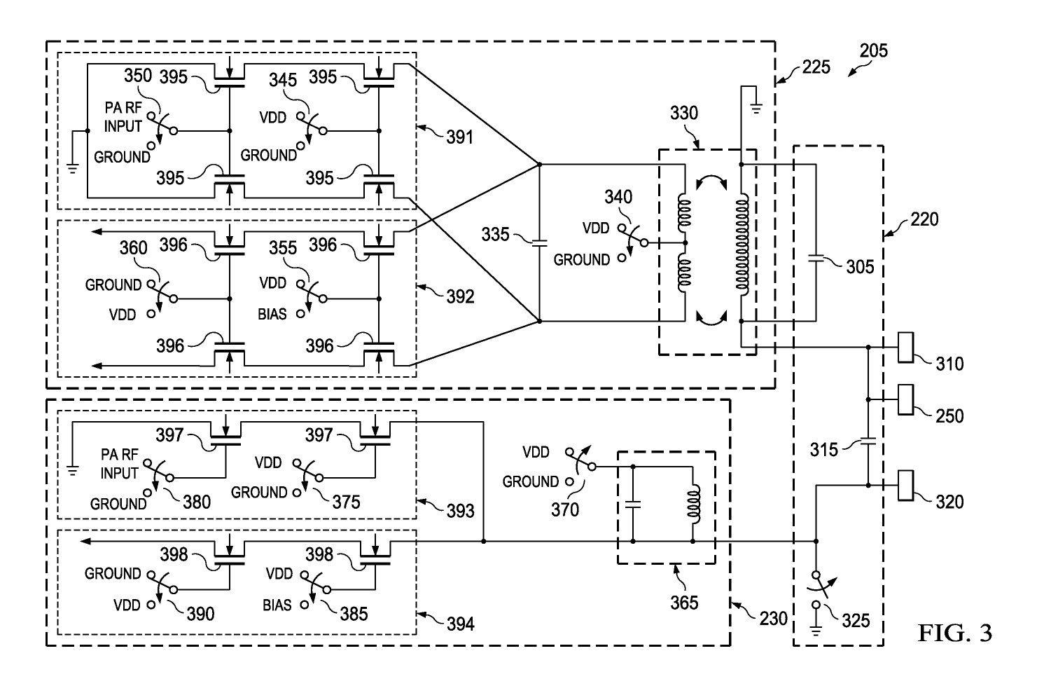

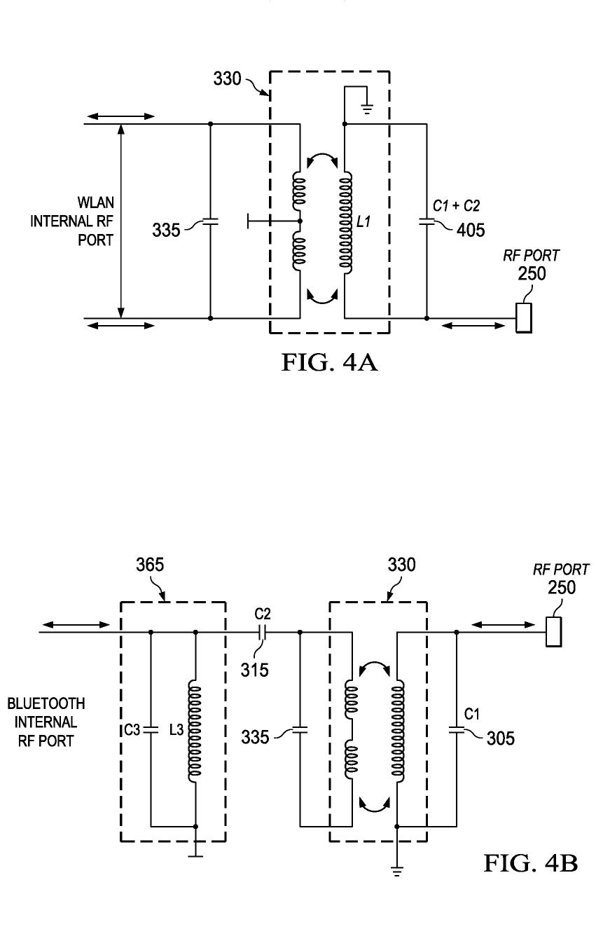

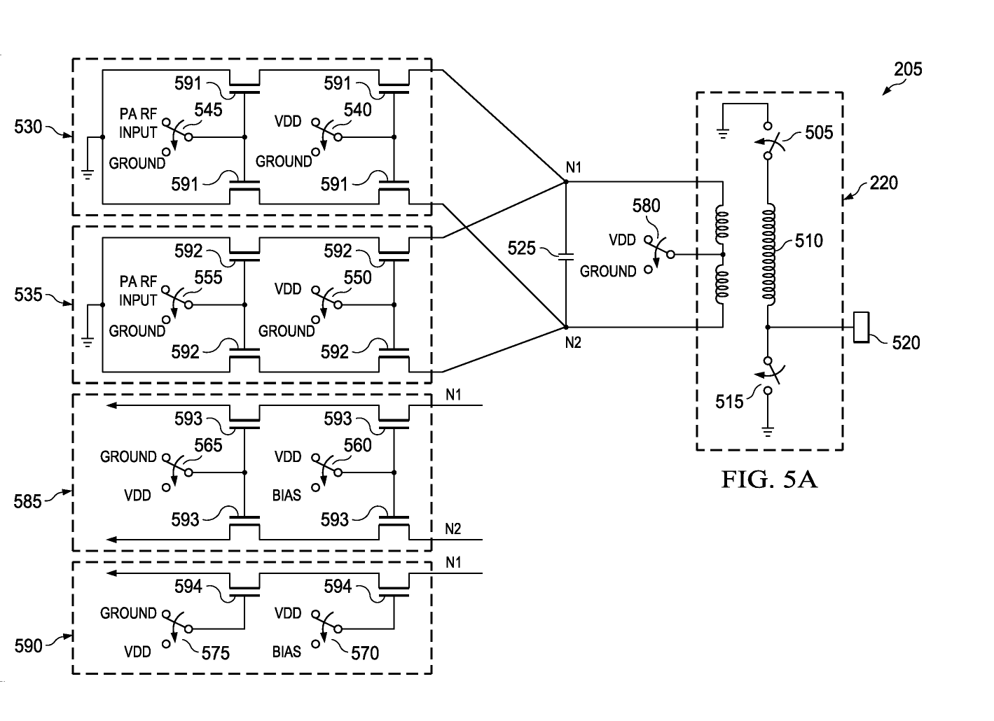

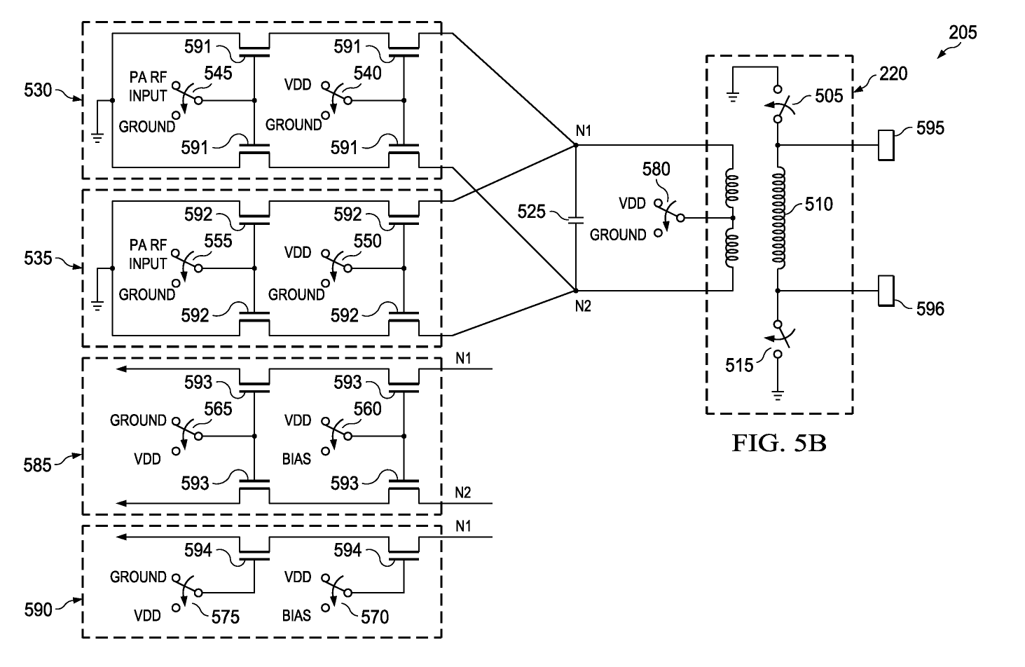

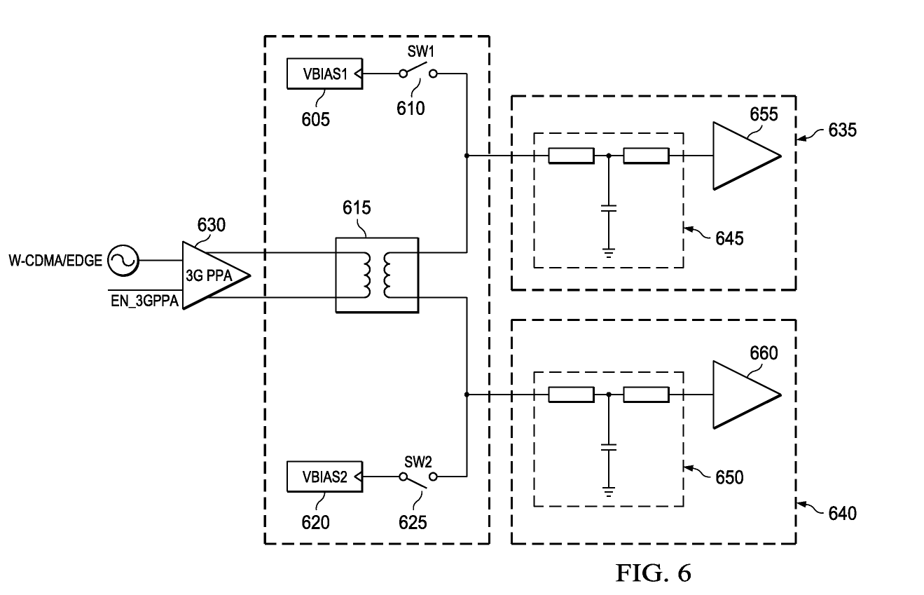

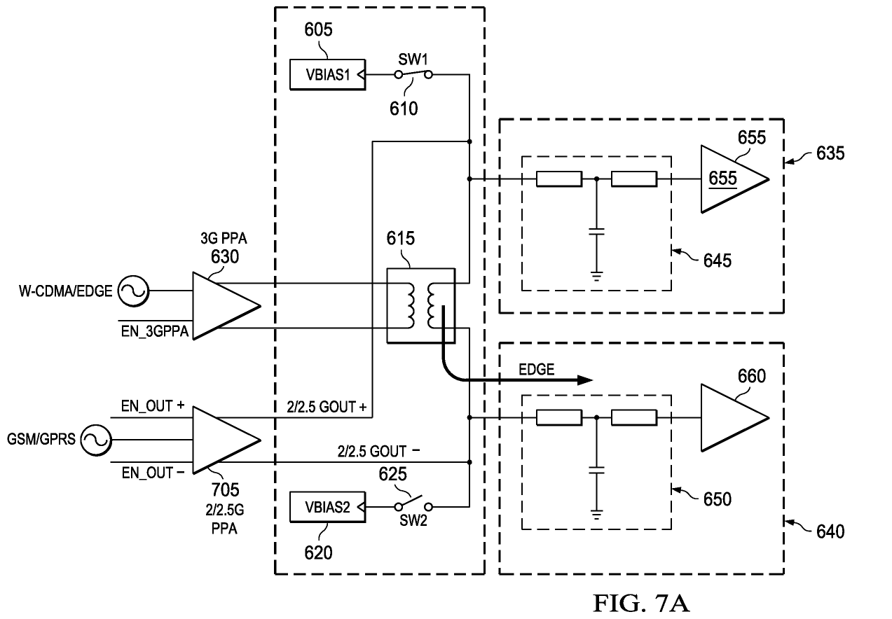

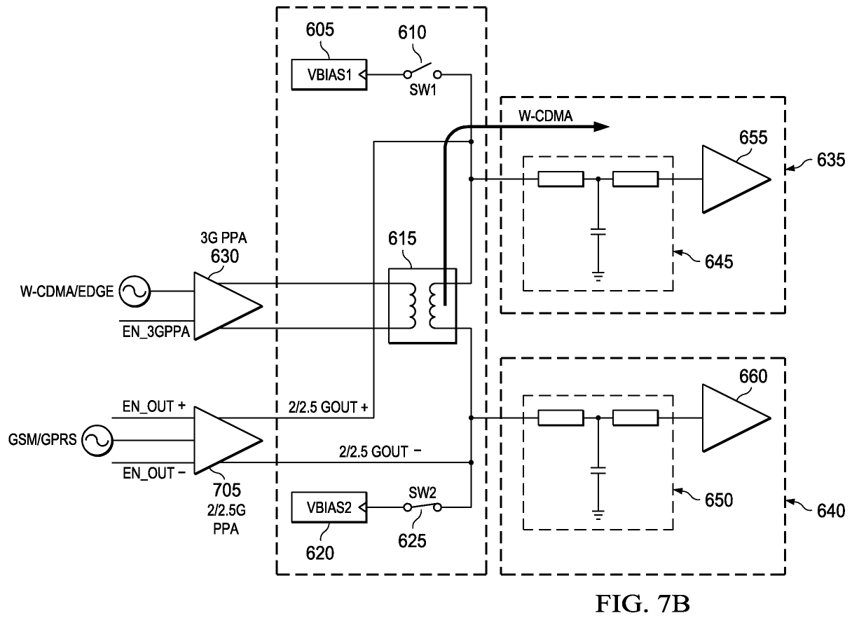

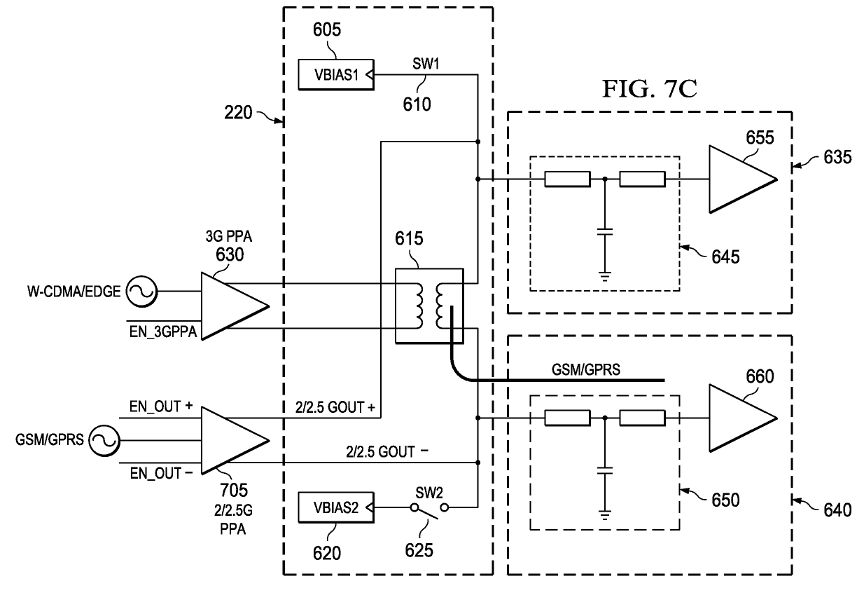

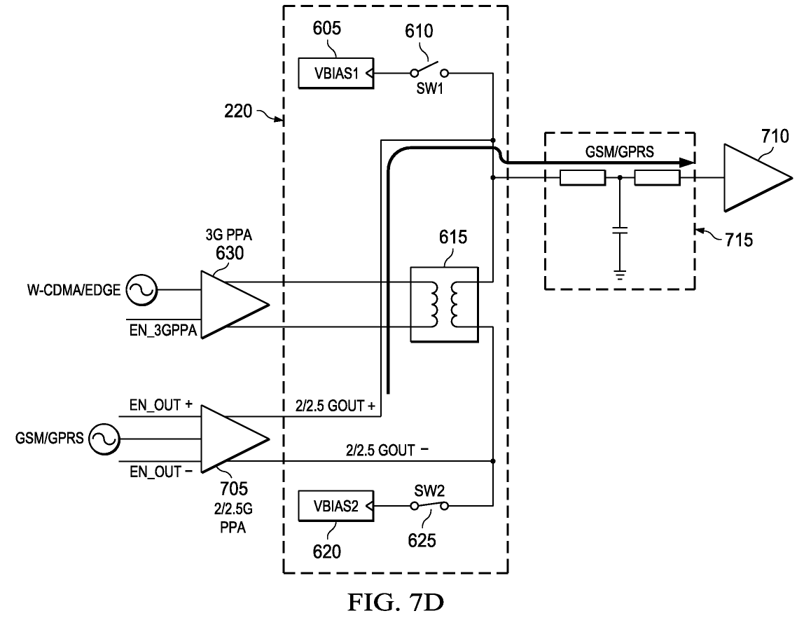

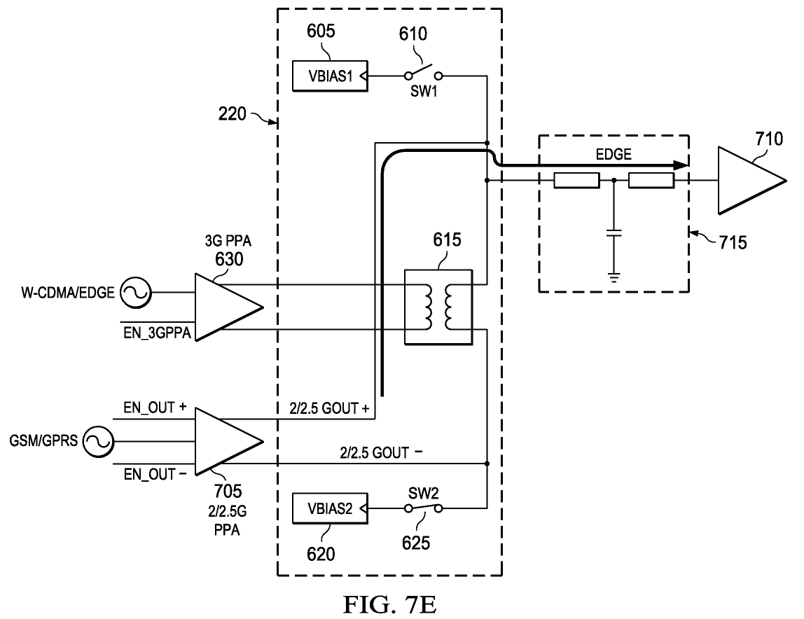

The circuit 220 is configurable to operate the transceiver 205 in at least one of the first mode and the second mode. The circuit 220 can be coupled to one or more ports, for example the port 250, a bluetooth port, a WLAN port, a zigbee port, a 2G port, a 2.5G port, and a 3G port. The port 250 and the one or more ports can be coupled to the filter 215. The circuit 220 including various elements is explained in conjunction with FIG. 3, FIG. 4A, FIG. 4B, FIG. 5A, FIG. 5B, FIG. 6, FIG. 7A, FIG. 7B, FIG. 7C, FIG. 7D, and FIG. 7E.

Referring to FIG. 3 now, the circuit 220 includes a first capacitor 305 (first element), hereinafter referred to as the capacitor 305, coupled to a WLAN port 310. The circuit 220 also includes a second capacitor 315 (second element), hereinafter referred to as the capacitor 315, coupled to the capacitor 305, the port 250, the WLAN port 310, and a bluetooth port 320. The circuit 220 further includes a switch 325 (first switch) coupled to the capacitor 315.

The capacitor 305 is coupled to a transmitting portion 391 and a receiving portion 392 of WLAN mode using a balun 330. In one embodiment, the balun 330 is used to couple portions of the transceiver 205 having different impedances. A capacitor 335 isolates the transmitting portion 391 from the receiving portion 392. The transmitting portion 391 is configurable to operate the circuit 225 as a transmitter in the WLAN mode using a switch 340, a switch 345, and a switch 350. The receiving portion 392 is configurable to operate the circuit 225 as a receiver in the WLAN mode using the switch 340, a switch 355, and a switch 360. The switch 345 and the switch 350 are coupled to transistors 395 that can function as the PA. The switch 355 and the switch 360 are coupled to transistors 396 that can function as the LNA.

The capacitor 315 is coupled to a transmitting portion 393 and a receiving portion 394 of the circuit 230 using a tuning circuit 365. The transmitting portion 393 is configurable to operate the circuit 230 as a transmitter in bluetooth mode using a switch 370, a switch 375, and a switch 380. The receiving portion 394 is configurable to operate the circuit 230 as a receiver in the bluetooth mode using the switch 370, a switch 385, and a switch 390. The switch 375 and the switch 380 are coupled to transistors 397 that can function as the PA. The switch 385 and the switch 390 are coupled to transistors 398 that can function as the LNA.

It is noted that the circuit 225 and the circuit 230 can include more elements than that illustrated. Further, the circuit 225 and the circuit 230, and functioning of the circuit 225 and the circuit 230 are explained in detail in U.S. application Ser. No. 12/435,668, entitled “CIRCUITS, PROCESSES, DEVICES AND SYSTEMS FOR FULL INTEGRATION OF RF FRONT END MODULE INCLUDING RF POWER AMPLIFIER”, assigned to Texas Instrument Incorporated, which is incorporated herein by reference in its entirety.

The switch 325 can be a metal oxide semiconductor switch that is responsive to a control signal to operate the transceiver 205 in one of the WLAN mode and the bluetooth mode in conjunction with the capacitor 305 and the capacitor 315. The control signal is generated based on a desired mode of operation of the transceiver 205. The desired mode of operation can be selected by a user of an electronic device that includes the transceiver 205. For example, a positive enable signal can be generated as the control signal if the desired mode is the WLAN mode and a negative enable signal can be generated as the control signal if the desired mode is the bluetooth mode. The positive enable signal closes the switch 325 and the negative enable signal opens the switch 325. The control signal can be generated within the transceiver 205 or the generation can be external to the transceiver 205.

In the WLAN mode, the switch 325 is closed. The capacitor 305 and the capacitor 315 provide a path when the switch 325 is closed. Equivalent capacitance for transmitting or receiving a signal in the WLAN mode is equal to sum of capacitance of the capacitor 305 (C1) and of the capacitor 315 (C2) as shown in the equation below.

Equivalent capacitance (C)=C1+C2

An equivalent circuit of the transceiver 205 in the WLAN mode is illustrated in FIG. 4A. The equivalent circuit includes the balun 330 that couples a high power differential output of the transceiver 205 to the port 250 in the WLAN mode. In one example, the balun 330 can be configured using low voltage metal oxide semiconductor switches. The equivalent capacitance is represented by a capacitor 405.

In the bluetooth mode, the switch 325 is open. The equivalent capacitance is equal to the capacitance of the capacitor 305.

Equivalent capacitance (C)=C1

The equivalent circuit of the transceiver 205 in the bluetooth mode is illustrated in FIG. 4B. The equivalent circuit represents a coupled RF filter having two resonators. In one example, a first resonator includes the tuning circuit 365 and a second resonator includes the balun 330 in conjunction with the capacitor 305. The RF filter having the two resonators couples a low power single-ended output of the transceiver 205 to the port 250 in the bluetooth mode.

In the WLAN mode, the switch 325 in conjunction with the capacitor 315 isolates a low power transceiver from high voltage swing due to PA of a high power transceiver. In one example, the low power transceiver includes the transmitting portion 393 and the receiving portion 394 and the high power transceiver includes the transmitting portion 391 and the receiving portion 392. The switch 325 in conjunction with the capacitor 315 also minimizes signal loss in the high power transceiver during the WLAN mode by isolating matching network of the low power transceiver. In one example, the matching network of the low power transceiver can be the tuning circuit 365.

In one embodiment, the transceiver 205 can transmit signals having output power, for example greater than 24 decibel milliwatt (dBm), in the WLAN mode by transforming 50 ohm impedance at the port 250 to a lower value using the balun 330. The transceiver 205 can also transmit signals having output power, for example, lower than 12 dBm in the bluetooth mode with minimum impedance transformation.

In another embodiment, when the capacitor 315 is not present, the WLAN port 310, the bluetooth port 320, and the port 250 can function independently.

Various configurations of the switches enabling various modes of the transceiver 205 are illustrated in Table 1.

TABLE 1

| | Switch | Switch | Switch | Switch | Switch | Switch | Switch | Switch | Switch | Switch | Switch |
|---|---|---|---|---|---|---|---|---|---|---|---|
| Mode | 340 | 345 | 350 | 355 | 360 | 370 | 375 | 380 | 385 | 390 | 325 |
| WLAN | GND | GND | GND | BIAS | VDD | D/C | D/C | D/C | D/C | D/C | CLOSED |
| Receive | | | | | | | | | | | |
| WLAN | VDD | VDD | PA RF | VDD | GND | D/C | D/C | D/C | D/C | D/C | CLOSED |
| Transmit | | | INPUT | | | | | | | | |
| Bluetooth | GND | GND | GND | GND | GND | GND | GND | GND | BIAS | VDD | OPEN |
| Receive | | | | | | | | | | | |
| Bluetooth | VDD | VDD | GND | VDD | GND | VDD | VDD | PA RF | VDD | GND | OPEN |
| Transmit | | | | | | | | INPUT | | | |
| Bluetooth | GND | GND | GND | BIAS | VDD | GND | GND | GND | BIAS | VDD | OPEN |
| and | | | | | | | | | | | |
| WLAN | | | | | | | | | | | |
| Receive | | | | | | | | | | | |

Referring to Table 1, D/C represents “Do Not Care” condition wherein switch configuration does not affect functionality of the transceiver 205, GND represents electrical ground connection, VDD represents power supply, bias represents biasing voltage, and PA RF Input represents the RF signal from the power amplifier.

Referring to FIG. 5A now, the circuit 220 includes a switch 505 (first element also referred to as a second switch), coupled to a transformer 510 (second element). The transformer 510 is coupled to a switch 515 (first switch), hereinafter referred to as the switch 515. The transformer 510 is coupled to a port 520. Examples of the port 520 include, but are not limited to, the RF port, the bluetooth port, the zigbee port, the WLAN port, the 2G port, the 2.5G port, and the 3G port.

The switch 505 and the switch 515 are coupled to a transmitting portion 530 of the WLAN mode and a transmitting portion 535 of the bluetooth mode using the transformer 510. The transmitting portion 530 is configurable as a transmitter in the WLAN mode using a switch 580, a switch 540 and a switch 545. The transmitting portion 535 is configurable as a transmitter in the bluetooth mode using the switch 580, a switch 550 and a switch 555. The switch 580 controls isolation between the transmitting portion 530 of the WLAN mode and the transmitting portion 535 of the bluetooth mode. The switch 580 also controls the isolation between a receiving portion 585 of the WLAN mode and a receiving portion 590 of the bluetooth mode. The receiving portion 585 of the WLAN mode and the receiving portion 590 of the bluetooth mode are coupled to the switch 505 and the switch 515 using the transformer 510. The receiving portion 585 is configurable as a receiver in the WLAN mode using the switch 580, a switch 560 and a switch 565. The receiving portion 590 is configurable as a receiver in the bluetooth mode using the switch 580, a switch 570 and a switch 575. The capacitor 525 in conjunction with the transformer 510 provides signal filtering and matching for the WLAN mode and the bluetooth mode.

The switch 540 and the switch 545 are coupled to transistors 591 that can function as at least one of the PA and the PPA in the transmitting portion 530 of the WLAN mode. The switch 560 and the switch 565 are coupled to transistors 593 that can function as a path to the LNA in the receiving portion 585 of the WLAN mode. The switch 550 and the switch 555 are coupled to transistors 592 that can function as at least one of the PA and the PPA in the transmitting portion 535 of the bluetooth mode. The switch 570 and the switch 575 are coupled to transistors 594 that can act as a path to the LNA in the receiving portion 590 of the bluetooth mode. The receiving portion 585 of the WLAN mode can be coupled to the capacitor 525 through nodes N1 and N2. The receiving portion 590 of the bluetooth mode can be coupled to the capacitor 525 through node N1.

The switch 540 and the switch 545 can be metal oxide semiconductor switches that are responsive to a control signal to operate the transceiver 205 in at least one of the WLAN mode and the bluetooth mode in conjunction with the transformer 510. The control signal can be a combination of one or more signals and can be generated based on desired mode of operation of the transceiver 205.

Various configurations of the switches in the transceiver 205 for various modes are illustrated in the Table 2.

TABLE 2

| | Switch | Switch | Switch | Switch | Switch | Switch | Switch | Switch | Switch | Switch | Switch |
|---|---|---|---|---|---|---|---|---|---|---|---|
| Mode | 580 | 540 | 545 | 560 | 565 | 550 | 555 | 570 | 575 | 505 | 515 |
| WLAN | GND | GND | GND | BIAS | VDD | GND | GND | VDD | GND | CLOSED | OPEN |
| Receive | | | | | | | | | | | |
| WLAN | VDD | VDD | PA RF | VDD | GND | GND | GND | VDD | GND | CLOSED | OPEN |
| Transmit | | | INPUT | | | | | | | | |
| Bluetooth | GND | GND | GND | GND | GND | GND | GND | BIAS | VDD | CLOSED | OPEN |
| Receive | | | | | | | | | | | |
| Bluetooth | VDD | GND | GND | VDD | GND | VDD | PA RF | VDD | GND | CLOSED | OPEN |
| Transmit | | | | | | | INPUT | | | | |
| Bluetooth | GND | GND | GND | BIAS | VDD | GND | GND | BIAS | VDD | CLOSED | OPEN |
| and | | | | | | | | | | | |
| WLAN | | | | | | | | | | | |
| Receive | | | | | | | | | | | |

Referring to Table 2, GND represents electrical ground connection, VDD represents power supply, Bias represents the biasing voltage and PA RF Input represents the RF signal from the power amplifier.

Referring to FIG. 5B now, the circuit 220 includes a switch 505 (first element), coupled to a transformer 510 (second element). The transformer 510 is coupled to a switch 515 (first switch). The transformer 510 is coupled to a port 595 and a port 596. In one example, the port 595 can be the WLAN port and the port 596 can be the bluetooth port. Examples of the port 595 and the port 596 can also include, but are not limited to, the RF port, the zigbee port, the 2G port, the 2.5G port, and the 3G port.

The switch 505 and the switch 515 are coupled to a transmitting portion 530 of the WLAN mode and a transmitting portion 535 of the bluetooth mode using the transformer 510. The transmitting portion 530 is configurable as a transmitter in the WLAN mode using a switch 580, a switch 540 and a switch 545. The transmitting portion 535 is configurable as a transmitter in the bluetooth mode using the switch 580, a switch 550 and a switch 555. The switch 580 controls isolation between the transmitting portion 530 of the WLAN mode and the transmitting portion 535 of the bluetooth mode. The switch 580 also controls the isolation between a receiving portion 585 of the WLAN mode and a receiving portion 590 of the bluetooth mode. The receiving portion 585 of the WLAN mode and the receiving portion 590 of the bluetooth mode are coupled to the switch 505 and the switch 515 using the transformer 510. The receiving portion 585 is configurable as a receiver in the WLAN mode using the switch 580, a switch 560 and a switch 565. The receiving portion 590 is configurable as a receiver in the bluetooth mode using the switch 580, a switch 570 and a switch 575. The capacitor 525 in conjunction with the transformer 510 provides signal filtering and matching for the WLAN mode and the bluetooth mode.

The switch 540 and the switch 545 are coupled to transistors 591 that can function as at least one of the PA and the PPA in the transmitting portion 530 of the WLAN mode. The switch 560 and the switch 565 are coupled to transistors 593 that can function as a path to the LNA in the receiving portion 585 of the WLAN mode. The switch 550 and the switch 555 are coupled to transistors 592 that can function as at least one of the PA and the PPA in the transmitting portion 535 of the bluetooth mode. The switch 570 and the switch 575 are coupled to transistors 594 that can act as a path to the LNA in the receiving portion 590 of the bluetooth mode. The receiving portion 585 of the WLAN mode can be coupled to the capacitor 525 through nodes N1 and N2. The receiving portion 590 of the bluetooth mode can be coupled to the capacitor 525 through node N1.

Various positions of each of the switches in the transceiver 205 for various modes are illustrated in the Table 3.

TABLE 3

| | Switch | Switch | Switch | Switch | Switch | Switch | Switch | Switch | Switch | Switch | Switch |
|---|---|---|---|---|---|---|---|---|---|---|---|
| Mode | 580 | 540 | 545 | 560 | 565 | 550 | 555 | 570 | 575 | 505 | 515 |
| WLAN | GND | GND | GND | BIAS | VDD | GND | GND | VDD | GND | CLOSED | OPEN |
| Receive | | | | | | | | | | | |
| WLAN | VDD | VDD | PA RF | VDD | GND | GND | GND | VDD | GND | CLOSED | OPEN |
| Transmit | | | INPUT | | | | | | | | |
| Bluetooth | GND | GND | GND | GND | GND | GND | GND | BIAS | VDD | OPEN | CLOSED |
| Receive | | | | | | | | | | | |
| Bluetooth | VDD | GND | GND | VDD | GND | VDD | PA RF | VDD | GND | OPEN | CLOSED |
| Transmit | | | | | | | INPUT | | | | |
| Bluetooth | GND | GND | GND | BIAS | VDD | GND | GND | BIAS | VDD | CLOSED | OPEN |
| and | | | | | | | | | | | |
| WLAN | | | | | | | | | | | |
| Receive | | | | | | | | | | | |

Referring to Table 3, GND represents electrical ground connection, VDD represents power supply, Bias represents the biasing voltage and PA RF Input represents the RF signal from the power amplifier.

It is noted that FIG. 5A and FIG. 5B are explained using two modes, the first mode and the second mode, and the transceiver 205 can have capability of selecting several modes. For example, the transformer 510 can include more number of coils to function as a switch that has capability of selecting more than two modes.

To illustrate the capability of the transformer 510 to select multiple RF outputs for different modes, a simplified form of the circuit 220 having the transmission portion corresponding to the modes is illustrated in FIG. 6. Referring to FIG. 6 now, the circuit 220 includes a first biasing circuit 605 (VBias1), hereinafter referred to as the biasing circuit 605, coupled to a first switch 610 (first element, SW1), hereinafter referred to as the switch 610. The switch 610 is coupled to a transformer 615 (second element, SW2). The circuit 220 includes a second biasing circuit 620 (Vbias2), hereinafter referred to as the biasing circuit 620, coupled to a second switch 625 (first switch), hereinafter referred as the switch 625. The second switch 625 is coupled to the transformer 615. The transformer 615 can be coupled to one or more ports and acts as a switch to select signal from a port of the one or more ports.

The circuit 220 is coupled to a circuit 635 (first circuit) that is configurable to operate as a transmitter in the first mode, for example the 3G mode. The circuit 220 is coupled to a circuit 640 (second circuit) that is configurable to operate as a transmitter in the second mode, for example a 2G mode and 2.5G mode. A network 645 is coupled between the transformer 615 and a PA 655 in the 3G mode that matches and isolates signals. A network 650 is coupled between the transformer 615 and a PA 660 in the 2G and 2.5G mode that matches and isolates the signals.

In one embodiment, the circuit 220 is coupled between a PPA 630 (3G PPA) and the PA 655 in the 3G mode and between the PPA 630 and a PA 660 in the 2G and 2.5G mode. The PPA 630 is coupled to a signal generator (W-CDMA/EDGE). The PPA 630 can receive an enable signal (EN_{—}3GPPA).

The switch 610 and the switch 625 can be metal oxide semiconductor switches that are responsive to a biasing voltage to operate the transceiver 205 in one of the 3G mode and at least one of the 2G and the 2.5G mode in conjunction with the transformer 615. Biasing voltages can be generated by the biasing circuit 605 and the biasing circuit 620. The biasing circuit 605 and the biasing circuit 620 can together be referred to as a biasing circuit. In one embodiment, the biasing circuit 605 and the biasing circuit 620 can be pre-programmed to generate the biasing voltages specific to the 3G mode, the 2G and 2.5G mode. The biasing voltages can be generated based on the desired mode of operation of the transceiver 205.

In one example, the switch 610 and the switch 625 can be complementary metal oxide semiconductor switches.

The circuit 220 can be used in a non-converged configuration and a converged configuration. The non-converged configuration can refer to transmission using separate PA and matching circuits between the 3G mode and the 2G and 2.5G modes. The converged configuration can refer to transmission in the 3G mode and 2G and 2.5G mode using a single PA and a single matching circuit.

It is noted that FIG. 6 is explained using two modes. However, the transformer 615 can include more number of coils to function as a switch that has capability of selecting more than two modes.

Signal transmission in the 3G mode utilizing EDGE non-converged mode and W-CDMA converged mode is explained in conjunction with FIG. 7A and FIG. 7B.

Referring to FIG. 7A now, the circuit 220 couples an EDGE signal from PPA 630 at one end to PA 660 at the other end in the non-converged EDGE mode.

Switch 610 is closed and switch 625 is open. A biasing circuit 605 is biased at a voltage VDD. True and complementary outputs of PPA 705 (2/2.5G PPA) are configured to a high impedance state. The switch 610 and the switch 625, and the biasing circuit 605 are configured to enable the EDGE signal from PPA 630 to couple through transformer 615 to circuit 640.

The PPA 705 is coupled to a signal generator (GSM/GPRS). The PPA 705 can receive signals, EN_OUT+ and EN_OUT−, and output signals 2/2.5GOUT+ and 2/2.5GOUT−

Referring to FIG. 7B now, the circuit 220 couples a W-CDMA signal from PPA 630 at one end to PA 655 at the other end in the W-CDMA converged mode.

Switch 610 is open and switch 625 is closed. A biasing circuit 620 is biased at a voltage equal to half of VDD. In one example the VDD=5V, and the biasing circuit 620 is biased at 2.5V. The true and complementary outputs of the PPA 705 are configured to the high impedance state. The switch 610 and the switch 625 and the biasing circuit 620 are configured to enable the signal from the PPA 630 to couple through transformer 615 to circuit 635.

Signal transmission in the 2G mode utilizing global system for mobile communication (GSM) and general packet radio service (GPRS) is explained in conjunction with FIG. 7C.

Referring to FIG. 7C now, in the 2G modes utilizing the GSM and the GPRS, the true and complementary outputs of PPA 630 is configured to the high impedance state and a 2G signal is driven through PPA 705.

In the 2G converged mode, biasing circuit 620 is biased to VDD, switch 625 is closed, and switch 610 is open. The true output of the PPA 705 is configured to the high impedance state and the complementary output of the PPA 705 is configured to provide a 2G signal. The 2G signal is coupled through the PPA 705 to the converged circuit 635. The transformer 615 functions as an RF choke while supplying a DC bias from the biasing circuit 620.

In the 2G non-converged mode, the biasing circuit 605 is biased to VDD, the switch 610 is closed, and the switch 625 is open. The true output of the PPA 705 is configured to the high impedance state and the complementary output of the PPA 705 is configured to provide the 2G signal. The 2G signal is coupled through the PPA 705 to non-converged circuit 640. The transformer 615 functions as an RF choke while supplying the DC bias from the circuit 605.

FIG. 7D is an exemplary illustration of signal transmission in a 2G converged mode using a single PA.

The true and complementary outputs of PPA 630 are configured to the high impedance state and a 2G signal is driven through PPA 705.

In the 2G converged mode, biasing circuit 620 is biased to VDD, switch 625 is closed, and switch 610 is open. The complementary output of the PPA 705 is configured to the high impedance state and the true output of the PPA 705 is configured to provide a 2G signal. The 2G signal is coupled from the PPA 705 to a PA 710 through a matching network 715. The PA 710 can be a 3G, 2G, and 2.5G converged PA. The matching network 715, for example can be a 3G matching network. The transformer 615 functions as an RF choke while supplying a DC bias from the circuit 620.

FIG. 7E is an exemplary illustration of signal transmission in a 3G converged mode using a single PA.

The true and complementary outputs of PPA 705 are configured to the high impedance state and a 3G signal is driven through PPA 630.

In the 3G converged mode, circuit 620 is biased to VDD, switch 625 is closed, and switch 610 is open. The 3G signal is coupled from the PPA 630 to a PA 710 through a matching network 715. A transformer 615 functions as an RF choke while supplying a DC bias from the circuit 620.

In one embodiment, the circuit 220, the circuit 635 and the circuit 640 can be present in the transceiver 205. Having the transformer 615, the switch 610 and the switch 625 reduces the cost of having separate transceiver and front end module.

In some embodiments, the capacitor 315, the capacitor 305, and the switch 325 reduces the cost of having separate transceiver and front end module.

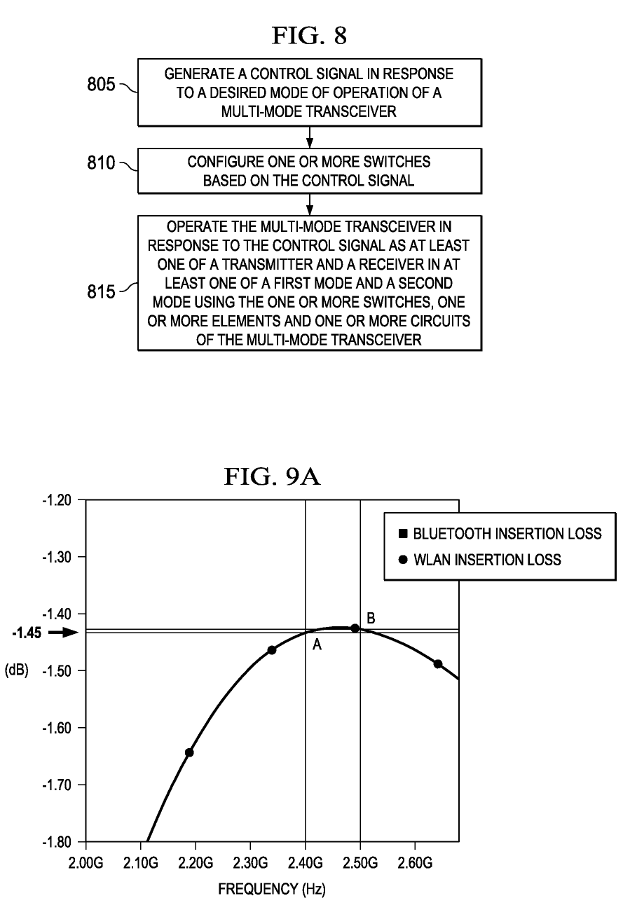

FIG. 8 is a flow chart illustrating a method for operating a multi-mode transceiver, for example the transceiver 205. The multi-mode transceiver can operate in at least one of a first mode and a second mode. The first mode can be one of a wireless local area network (WLAN) mode, a bluetooth mode, a Zigbee mode, a wideband code division multiple access (W-CDMA) mode, an enhanced data rates for global system mobile communication evolution (EDGE) mode, a 3G mode, a 2.5G mode and a 2G mode. The second mode can be one of the WLAN mode, the bluetooth mode, the Zigbee mode, the W-CDMA mode, the EDGE mode, the 3G mode, the 2.5G mode and the 2G mode.

At step 805, a control signal is generated in response to a desired mode of operation of the multi-mode transceiver. The desired mode can be selected based on an input of a user of an electronic device including the multi-mode transceiver.

In some embodiments, step 805 can be performed by the multi-mode transceiver or by a circuit external to the multi-mode transceiver.

At step 810, one or more switches of the multi-mode transceiver are configured based on the control signal. The control signal can also include biasing voltages. In one example, the switch 325 of the transceiver 205 of FIG. 3 or the switch 505 and the switch 515 of the transceiver 205 of FIG. 5A and FIG. 5B can be configured using the control signal. In another example, the switch 610 and the switch 625 of FIG. 6 can be configured using the biasing voltages.

At step 815, the multi-mode transceiver is operated in response to the control signal as at least one of a transmitter and a receiver in at least one of the first mode and the second mode using the one or more switches, one or more elements and one or more circuits of the multi-mode transceiver. In one example, the multi-mode transceiver is operated in at least one of the WLAN mode or the bluetooth mode using the switch 325, the capacitor 305, and the capacitor 315 of the transceiver 205 of FIG. 3. In another example, the multi-mode transceiver is operated in at least one of the WLAN mode or the bluetooth mode using the switch 505, the switch 515, and the transformer 510 of FIG. 5A and FIG. 5B. The switch 505, the switch 515, and the transformer 510 can also be used to operate the multi-mode transceiver in the 3G mode or the 2G/2.5G mode. In yet another example, the multi-mode transceiver is operated in the 3G mode or the 2G/2.5G mode using the switch 610, the switch 625, and the transformer 615 of FIG. 6.

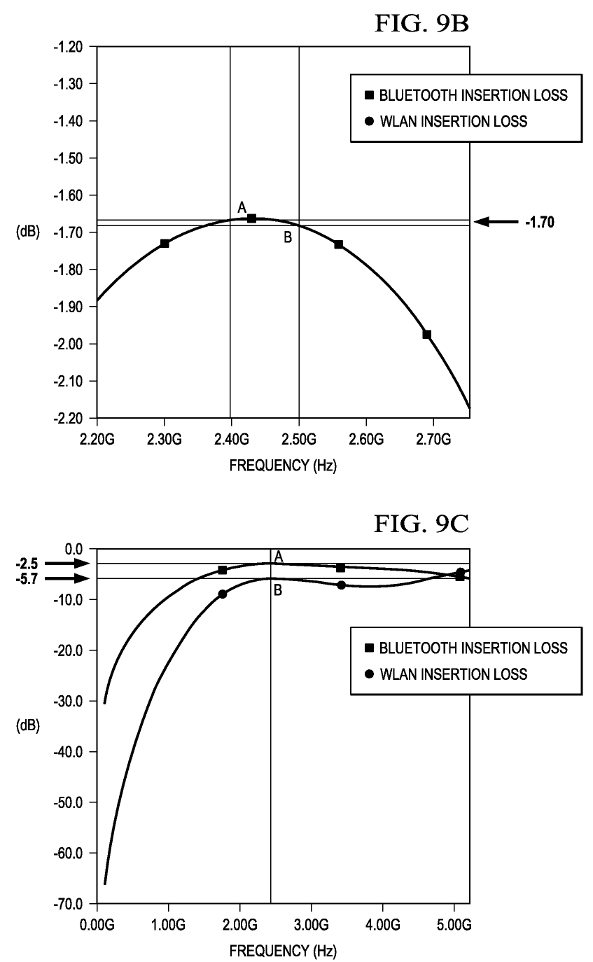

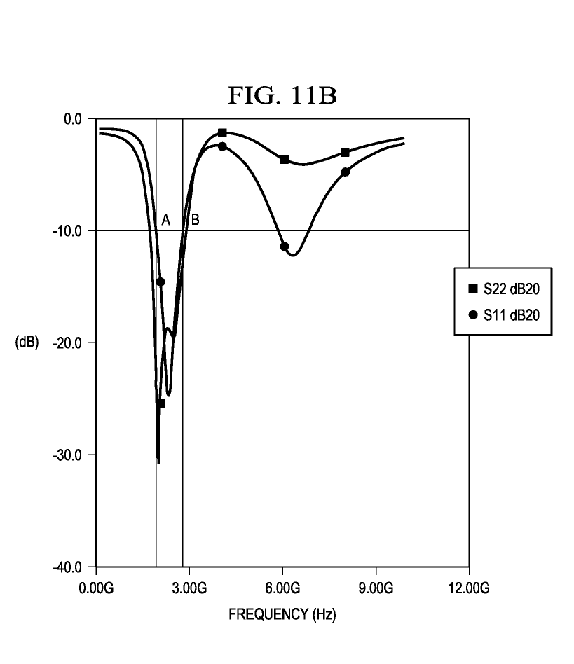

FIG. 9A is a graphical representation illustrating insertion loss for a multi-mode transceiver, for example the transceiver 205 of FIG. 3, operating in a WLAN mode. Insertion loss is loss of signal power due to insertion of a device, for example the multi-mode transceiver, in a network. In one example, the insertion loss is negative 1.45 decibel (−1.45 dB) for one of transmitting and receiving a signal in the WLAN mode. The insertion loss can be determined from scattering parameter analysis. Scattering parameter analysis is used to determine various parameters in a system. Examples of the parameters include, but are not limited to loss, gain, and stability of the system. The scattering parameter analysis for the WLAN mode is illustrated in FIG. 11A.

FIG. 9B is a graphical representation illustrating insertion loss for a multi-mode transceiver, for example the transceiver 205 of FIG. 3, operating in a bluetooth mode. In one example, the insertion loss is negative 1.45 dB (−1.45 dB) for one of transmitting and receiving a signal in the bluetooth mode. The scattering parameter analysis for the bluetooth mode is illustrated in FIG. 11B.

FIG. 9C is a graphical representation illustrating insertion loss for a multi-mode transceiver, for example the transceiver 205 of FIG. 3, operating in wireless local area network mode and bluetooth mode. The multi-mode transceiver operates to receive a signal in the wireless local area network mode and the bluetooth mode. The insertion loss is negative 2.5 dB (−2.5 dB) for receiving the signal in the WLAN mode and the insertion loss is negative 5.7 dB (−5.7 dB) for receiving the signal in the bluetooth mode. The insertion loss in the WLAN mode and the bluetooth mode is asymmetric loss and can be controlled based on capacitance of the capacitor 305 and of the capacitor 315 illustrated in FIG. 3.

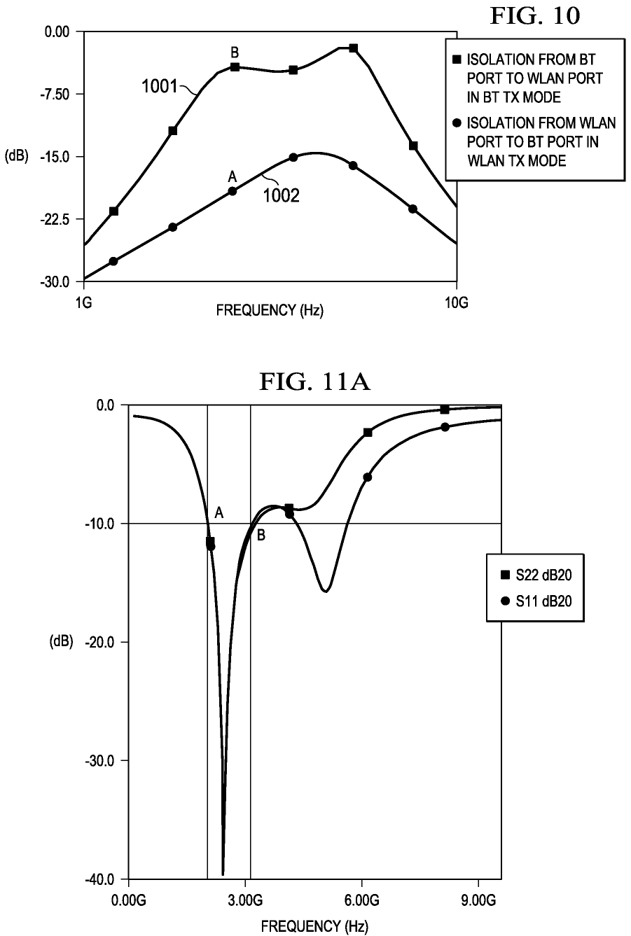

FIG. 10 is a graphical representation illustrating insertion loss for a multi-mode transceiver, for example the transceiver 205 of FIG. 3, operating in wireless local area network mode and bluetooth mode. The insertion loss while isolating from a bluetooth port to a WLAN port in bluetooth transmission mode is illustrated in graph 1001. The insertion loss while isolating from a WLAN port to a bluetooth port in WLAN transmission mode is illustrated in graph 1002. The isolation in the multi-mode transceiver is achieved using low power switches.

In the foregoing discussion, the term “coupled” refers to either a direct electrical connection between the devices connected or an indirect connection through intermediary devices. The term “signal” means at least one current, voltage, charge, data, or other signal.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A multi-mode transceiver comprising:
a first circuit that is configurable to operate as one of a transmitter and a receiver in a first mode;
a second circuit that is configurable to operate as one of the transmitter and the receiver in a second mode;
a first element coupled to the first circuit;
a second element coupled to the first element and one or more ports; and
a first switch, coupled to the second element and to the second circuit, that is configurable to operate the multi-mode transceiver in at least one of the first mode and the second mode in conjunction with the first element and the second element.

2. The multi-mode transceiver as claimed in claim 1, wherein the first element comprises a second switch and the second element comprises a transformer that acts as a switch.

3. The multi-mode transceiver as claimed in claim 2, wherein the first switch and the second switch are metal oxide semiconductor switches that are responsive to a control signal to operate the multi-mode transceiver in at least one of the first mode and the second mode in conjunction with the transformer, the control signal being generated based on a desired mode of operation of the multi-mode transceiver.

4. The multi-mode transceiver as claimed in claim 2, wherein the first switch, the second switch and the transformer are coupled between at least one of:
a power amplifier of the multi-mode transceiver and the one or more ports; and
the one or more ports and a low noise amplifier of the multi-mode transceiver.

5. The multi-mode transceiver as claimed in claim 1, wherein the first element comprises a first capacitor and the second element comprises a second capacitor.

6. The multi-mode transceiver as claimed in claim 5, wherein the first switch is a metal oxide semiconductor switch that is responsive to a control signal to operate the multi-mode transceiver in at least one of the first mode and the second mode in conjunction with the first capacitor and the second capacitor, the control signal being generated based on a desired mode of operation of the multi-mode transceiver.

7. The multi-mode transceiver as claimed in claim 6, wherein the first capacitor, the second capacitor and the first switch are coupled between at least one of:
a power amplifier of the multi-mode transceiver and the one or more ports; and
the one or more ports and a low noise amplifier of the multi-mode transceiver.

8. The multi-mode transceiver as claimed in claim 1, wherein the first circuit comprises at least one of:
a power amplifier;
a pre-power amplifier; and
a low noise amplifier.

9. The multi-mode transceiver as claimed in claim 1, wherein the second circuit comprises at least one of:
a power amplifier;
a pre-power amplifier; and
a low noise amplifier.

10. The multi-mode transceiver as claimed 1, wherein the one or more ports comprise at least one of:
a radio frequency port;
a wireless local area network port;
a bluetooth port;
a zigbee port;
a 3G port;
a 2G port; and
a 2.5G port.

11. The multi-mode transceiver as claimed in claim 1, wherein the first mode is at least one of a wireless local area network mode, a bluetooth mode, a zigbee mode, a 3G mode, a 2.5G mode and a 2G mode.

12. The multi-mode transceiver as claimed in claim 1, wherein the second mode is at least one of a wireless local area network mode, a bluetooth mode, a zigbee mode, a 3G mode, a 2.5G mode and a 2G mode.

13. A multi-mode transmitter comprising:
a first circuit that is configurable to operate in a first mode;
a second circuit that is configurable to operate in a second mode;
a transformer, coupled to the first circuit and the second circuit, that acts as a switch to operate the multi-mode transmitter in one of the first mode and the second mode; and
a plurality of switches, coupled to the transformer, that are responsive to a biasing voltage to operate the multi-mode transmitter in one of the first mode and the second mode in conjunction with the transformer, the biasing voltage being generated based on a desired mode of operation of the multi-mode transmitter.

14. The multi-mode transmitter as claimed in claim 13 and further comprising:
a biasing circuit coupled to the plurality of switches to generate the biasing voltage based on the desired mode of operation of the multi-mode transmitter.

15. The multi-mode transmitter as claimed in claim 13, wherein the plurality of switches and the transformer are coupled between a pre-power amplifier and a power amplifier of the multi-mode transmitter.

16. The multi-mode transmitter as claimed in claim 13, wherein the first mode is at least one of 2G mode and 2.5G mode, and the second mode is a 3G mode.

17. A multi-mode transceiver comprising:
a first circuit that is configurable to operate as one of a transmitter and a receiver in a first mode;
a second circuit that is configurable to operate as one of the transmitter and the receiver in a second mode;
a first capacitor coupled to one or more ports and the first circuit;
a second capacitor coupled to the one or more ports, the first capacitor and the second circuit; and
a switch, coupled to the second capacitor, that is responsive to a control signal to operate the multi-mode transceiver in at least one of the first mode and the second mode in conjunction with the first capacitor and the second capacitor, the control signal being generated based on a desired mode of operation of the multi-mode transceiver.

18. The multi-mode transceiver as claimed in claim 17, wherein the switch is a metal oxide semiconductor switch.

19. The multi-mode transceiver as claimed in claim 17, wherein the first mode is a wireless local area network mode and the second mode is a bluetooth mode.
